(19) United States
(12) Patent Application Publication
(10) Pub. No.: US 2023/0086594 A1
(43) Pub. Date: Mar. 23, 2023

(54) Ride-Sharing Matching Method and System

(71) Applicants: Hyundai Motor Company, Seoul (KR); Kia Corporation, Seoul (KR)

(72) Inventor: Kyungjin You, Anyang-si (KR)

(21) Appl. No.: 17/584,537

(22) Filed: Jan. 26, 2022

(30) Foreign Application Priority Data
Sep. 23, 2021 (KR) 10-2021-0125450

(51) Int. Cl. G01C 21/34; G06Q 10/02

(52) U.S. Cl. CPC G01C 21/3438; G01C 21/343; G01C 21/3492; G01C 21/3484; G06Q 10/025

(57) ABSTRACT

An embodiment ride-sharing matching method includes receiving a call request, a ride-sharing request, and a ride-sharing condition from each of a plurality of user terminals, deriving a plurality of paths drivable by a vehicle for each of the ride-sharing requests, deriving at least one path combination by tying at least two paths among the plurality of paths, and determining a final matching combination including the path combination that satisfies each of the ride-sharing conditions based on a path coincidence degree threshold value, an additional fare discount threshold value, an additional required time limit, and a personal information condition.

### CROSS-REFERENCE TO RELATED APPLICATIONS

This application claims the benefit of Korean Patent Application No. 10-2021-0125450, filed on Sep. 23, 2021, which application is hereby incorporated herein by reference.

### TECHNICAL FIELD

The present invention relates to a ride-sharing matching method and a system using the same.

### BACKGROUND

Conventionally, there are cases that users who use a taxi may not only board a vehicle alone oneself or with a party, but also board the vehicle with other users that are not a party, that is, ride together. However, the conventional ride-sharing was mainly done by selecting a ride-sharing person and riding together from the time of boarding the vehicle, and the need for a service in which a user other than the party may additionally board the vehicle while already boarding the vehicle with yourself or a party and driving has been raised. In addition, with the development of shared mobility services, the need for a system that may allow riding in the vehicle with other users other than the party has been raised for reasons such as fare discounts.

The above information disclosed in this Background section is only for enhancement of understanding of the background of the invention, and therefore it may contain information that does not form the prior art that is already known to a person of ordinary skill in the art.

### SUMMARY

It is possible to set whether or not to ride with a ride-sharing person and a condition for riding together when using the taxi service, so that the riding that satisfies the riding condition is accepted even while the taxi is driving, thereby increasing the user's satisfaction with the ride service provided by the sharing system.

A ride-sharing matching method according to embodiments of the present invention includes receiving, by a ride-sharing matching server, a call request, a ride-sharing request, and a ride-sharing condition from a plurality of user terminals, deriving, by the ride-sharing matching server, a plurality of paths capable of moving through a vehicle for each of a plurality of users who have requested the ride-sharing, deriving, by the ride-sharing matching server, at least one path combination by tying at least two paths among a plurality of paths, and determining, by the ride-sharing matching server, a path combination that satisfies the ride-sharing condition among at least one path combination as a final matching combination based on a path coincidence degree threshold value, an additional fare discount threshold value, an additional required time limit, and a personal information condition of each user constituting at least one path combination.

The determining as the final matching combination may include deriving, by the ride-sharing matching server, a path coincidence degree with the path when another user rides the vehicle alone for the path when the user rides the vehicle alone, and deriving, by the ride-sharing matching server, the path combination including the user whose path coincidence degree is equal to or greater than the path coincidence degree threshold value of the user and another user as the candidate path combination.

The determining as the final matching combination may include excluding, by the ride-sharing matching server, the corresponding path combination from the candidate path combination if the discount fare applied when vehicle ride-sharing with other users is less than the additional fare discount threshold value.

The determining as the final matching combination may include excluding the corresponding path combination from the candidate path combination by the ride-sharing matching server in a case the additional required time expected to be required for the vehicle ride-sharing with another user exceeds the additional required time limit compared with a case of riding in the vehicle alone.

The determining as the final matching combination may include excluding the corresponding path combination from the candidate path combination when the personal information of another user does not meet the personal information condition by the ride-sharing matching server.

The excluding from the candidate path combination may include deriving, by the ride-sharing matching server, a safety score of another user based on the evaluation score for another user and the number of taxi use times of another user, and excluding, by the ride-sharing matching server, the corresponding path combination from the candidate path combination when the safety score of another user is less than a certain level.

The deriving as the candidate path combination may include deriving, by the ride-sharing matching server, a combination movement path that is changed by combining the paths of the user and another user constituting the path combination.

The determining as the final matching combination may further include excluding, by the ride-sharing matching server, the corresponding path combination from the candidate path combination when the walking distance of the user according to the combination movement path exceeds a corresponding walking distance limit.

The method may further include transmitting, by the ride-sharing matching server, matching information to the user terminal of each user constituting the final matching combination.

The matching information may include the path coincidence degree, the discount fare, the additional required time, the personal information of another user constituting the final matching combination of each user, and the combination movement path with another user.

The method may further include receiving, by the ride-sharing matching server, an evaluation score for another user constituting the final matching combination from the user terminal of each user constituting the final matching combination.

A ride-sharing matching system of embodiments of the present invention as a ride-sharing matching system for a ride-sharing matching of a user and another user includes a ride-sharing matching server for deriving a plurality of paths that are changeable through a vehicle for each of a plurality of users using a plurality of user terminals, tying at least two paths among a plurality of paths to derive at least one path combination, and determining a path combination that satisfies the ride-sharing condition among the path combinations as a final matching combination upon receiving a call request, a ride-sharing request, and a ride-sharing condition from a plurality of user terminals.

The ride-sharing matching server may include a path module deriving the path combination as the candidate path combination if the path coincidence degree of the path of the user constituting the path combination with the path of another user constituting the combination is greater than or equal to a path coincidence degree threshold value of the user.

The ride-sharing matching server may further include a fare module excluding the corresponding path combination from the candidate path combination when the discount fare applied to the user is less than an additional fare discount threshold value of the user during the vehicle ride-sharing of the user and another user.

The ride-sharing matching server may further include a time module excluding the path combination from the candidate path combination when the expected additional required time for the user exceeds an additional required time limit of the user upon the vehicle ride-sharing of the user and another user.

The ride-sharing matching server may further include a personal information module excluding the corresponding path combination from the candidate path combination when the personal information of another user does not meet the personal information condition of the user.

The personal information module may derive a safety score of another user based on an evaluation score for another user and a number of taxi uses of another user, and exclude the corresponding path combination from the candidate path combination if the derived safety score is less than a certain level.

The ride-sharing matching server may further include a matching module receiving an evaluation score for another user constituting the final matching combination from the user terminal of each user constituting the final matching combination.

When using a taxi service, it is possible to set whether or not a ride-sharing satisfies a ride-sharing condition, so that the ride-sharing that satisfies the ride-sharing condition is accepted even while the taxi is running, thereby providing the ride-sharing matching method and the ride-sharing matching system that are improved with user satisfaction with the ride-sharing service provided by the ride-sharing system.

### BRIEF DESCRIPTION OF THE DRAWINGS

FIG. 1 is a block diagram schematically showing a configuration of a ride-sharing matching system according to an exemplary embodiment.

FIG. 2 is a flowchart of a ride-sharing matching method according to an exemplary embodiment.

FIG. 3 is a detailed flowchart showing a step of receiving a call request and a ride-sharing request of FIG. 2.

FIG. 4 and FIG. 5 are views showing a screen provided through an application of a user terminal according to an exemplary embodiment.

FIG. 6 is a detailed flowchart showing a matching step of FIG. 2.

FIG. 7 is a detailed flowchart showing a step (S510) of FIG. 6.

FIG. 8 is a detailed flowchart showing a step (S540) of FIG. 6.

FIG. 9 is a detailed flowchart showing a step (S550) of FIG. 6 when a candidate two-person path combination is multiple.

FIG. 10 is a flowchart of a ride-sharing matching method according to an exemplary embodiment.

The following elements may be used in connection with the drawings to describe embodiments of the present invention.

1: ride-sharing matching system

100: ride-sharing matching server

110 : path module

120: fare module

130: time module

140: personal information module

150: matching module

160: database

200: user terminal

210: application

### DETAILED DESCRIPTION OF ILLUSTRATIVE EMBODIMENTS

Embodiments of the present invention relate to a ride-sharing matching method and a system using the same for a taxi user who chooses to ride a taxi together with another user. According to embodiments of the present invention, a taxi service user, when wanting to use a taxi service, may request taxi ride-sharing, and may be matched with other taxi service users who meet a ride-sharing condition input by the taxi service user before or during the operation of the taxi. In relation to taxi ride-sharing matching, the ride-sharing stability of the ride-sharing person may be improved by allowing the ride-sharing person, not the taxi driver, to set the conditions of other ride-sharing persons.

Hereinafter, embodiments disclosed in the present specification will be described in detail with reference to the accompanying drawings. In the present specification, the same or similar constituent elements will be denoted by the same or similar reference numerals, and an overlapped description thereof will be omitted. The terms “module” and “unit” for components used in the following description are used only in order to easily make a specification. Therefore, these terms do not have meanings or roles that distinguish them from each other in themselves. Further, in describing embodiments of the present specification, when it is determined that a detailed description of the well-known art associated with the present invention may obscure the gist of the present invention, it will be omitted. In addition, the accompanying drawings are provided only in order to allow embodiments disclosed in the present specification to be easily understood and are not to be interpreted as limiting the spirit disclosed in the present specification, and it is to be understood that the present invention includes all modifications, equivalents, and substitutions without departing from the scope and spirit of the present invention.

Terms including ordinal numbers such as first, second, and the like will be used only to describe various components, and are not to be interpreted as limiting these components. The terms are only used to differentiate one component from other components.

It will be further understood that the terms “comprise” or “have” used in the present specification specify the presence of stated features, numerals, steps, operations, components, parts, or a combination thereof, but do not preclude the presence or addition of one or more other features, numerals, steps, operations, components, parts, or a combination thereof.

In a configuration for controlling other configurations in a specific control condition among configurations according to an embodiment, a program implemented as a set of instructions embodying a control algorithm necessary to control other configurations may be installed. The control configuration may generate output data by processing input data and stored data according to the installed program. The control configuration may include a non-volatile memory to store the programs and a memory to store the data.

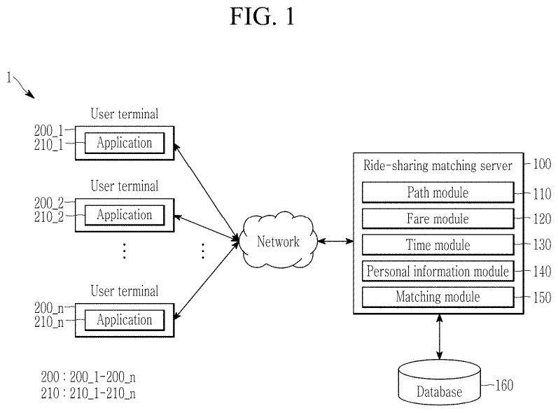

FIG. 1 is a block diagram schematically showing a configuration of a ride-sharing matching system according to an exemplary embodiment.

Referring to FIG. 1, a ride-sharing matching system 1 may include a ride-sharing matching server 100 and a plurality of user terminals 200_1 to 200_n, and each component is connected to each other through a network. Also, a plurality of applications 210_1 to 210_n are installed in the plurality of user terminals 200_1 to 200_n, respectively.

Hereinafter, when describing the common operation and technical characteristics of the plurality of user terminals 200_1 to 200_n, they are referred to as a user terminal 200. When describing the common operation and technical characteristics of the plurality of applications 210_1 to 210_n, they are referred to as an application 210.

Here, the ride-sharing matching server 100 may be a server that manages a taxi mobility platform or a fleet system server. The taxi mobility platform may be a platform using a taxi terminal using a plurality of applications in which various functions necessary for a taxi operation are implemented and a data storage unit that transmits data written by each of a plurality of applications to a related application. The fleet system server may mean a server for managing a fleet.

The ride-sharing matching server 100 may include a path module no, a fare module 120, a time module 130, a personal information module 140, and a matching module 150. The database 160 in which the ride-sharing matching server 100 stores the data may include a ride-sharing request, a ride-sharing condition, and ride-sharing person evaluation information.

Hereinafter, in order to distinguish each of two user terminals specified for describing the ride-sharing matching system 1 among the plurality of user terminals 200_1 to 200_n, each of two user terminals may be expressed as a user terminal 200_i and another user terminal 200_j.

Also, among the plurality of applications 210_1 to 210_n, the applications installed in one user terminal 200_i and another user terminal 200_j are expressed as an application 210_i and another application 210_j, respectively.

In this specification, the ride-sharing may indicate that a user using a user terminal 200_i and another user using another user terminal 200_j ride in one vehicle together in boarding the vehicle such as a taxi.

In addition, the ride-sharing matching may indicate that the ride-sharing matching server 100 derives one path combination by tying the user's path and the other user's path so that the user and other users may ride together.

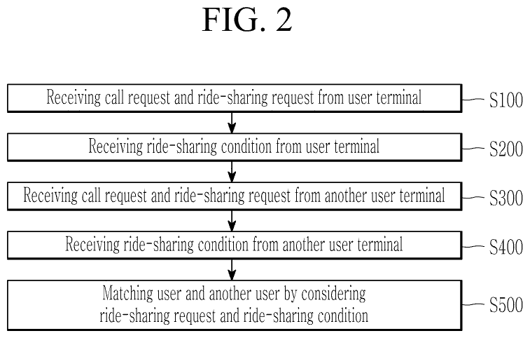

FIG. 2 is a flowchart of a ride-sharing matching method according to an exemplary embodiment.

The ride-sharing matching server 100 receives a call request and a ride-sharing request from the user terminal 200_i (S100).

The call request is a request for approval of either a vehicle terminal mounted on the vehicle or a driver terminal used by the vehicle's driver as the user subscribes to board the vehicle. The call request may include a departure and destination information for a vehicle dispatch.

The ride-sharing request is that the user agrees to the vehicle ride-sharing with another user.

Hereinafter, it is described in detail with reference to the detailed flowchart.

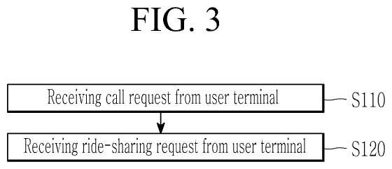

FIG. 3 is a detailed flowchart showing a step of receiving a call request and a ride-sharing request of FIG. 2.

In FIG. 2, the receiving (S100) of the call request and the ride-sharing request from the user terminal and the receiving (S300) of the call request and the ride-sharing request from another user terminal may include call request receiving and ride-sharing request receiving, respectively.

Hereinafter, it is described based on the step (S100). This description may be equally applied to the step (S300) by changing the operation of the user terminal 200_i to the operation of the other user terminal 200_j.

The ride-sharing matching server 100 receives a call request from the user terminal 200_1 (S110).

The ride-sharing matching server 100 may present a user interface (UI) capable of inputting the call request through the application 210_i of the user terminal 200_i.

The user terminal 200_i may transmit the input call request to the ride-sharing matching server 100.

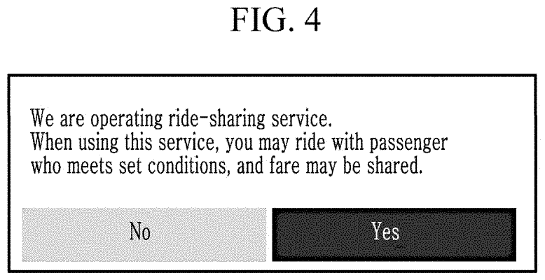

FIG. 4 is a view showing a screen provided through an application of a user terminal according to an exemplary embodiment.

Referring to FIG. 4, the ride-sharing matching server 100 may present a user interface capable of inputting a ride-sharing request through the application 210_i of the user terminal 200_i executing the call request.

In FIG. 3, the ride-sharing matching server 100 receives the ride-sharing request from the user terminal 200_i (S120).

Referring to FIG. 4, when the user selects the option marked “Yes” on the corresponding screen, the user terminal 200_i may transmit the ride-sharing request to the ride-sharing matching server 100.

In FIG. 2, the ride-sharing matching server 100 receives the ride-sharing condition from the user terminal 200_i (S200).

Hereinafter, the degree to which two or more paths coincide is referred to as a path coincidence degree.

The ride-sharing condition may include a path coincidence degree condition, an additional fare discount condition, an additional required time condition, and a personal information condition.

The path coincidence degree condition may indicate a threshold value of a path coincidence degree in which a user may be matched with other users. The path of each user may include a path that can be traveled via the vehicle from the departure to the destination of the user input through each of the user terminals 200_i, 200j.

The additional fare discount condition may indicate a threshold value of the additional fare discount that a user may be matched with other users.

The additional required time condition may indicate a limit of the additional required time that a user may be matched with other users.

The personal information condition may include a condition of personal information in which a user may be matched with other users.

Also, the ride-sharing condition may include a walking distance condition.

The walking distance condition may include a limit of a walking distance that a user may be matched with other users.

The user terminal 200_i may transmit the input ride-sharing condition to the ride-sharing matching server 100 when the ride-sharing condition is input from the user. The ride-sharing condition may be input as a specific value or may be input in a certain range.

In addition, the ride-sharing matching server 100 may store the ride-sharing request and the ride-sharing condition received from the user terminal 200_i in the database 160.

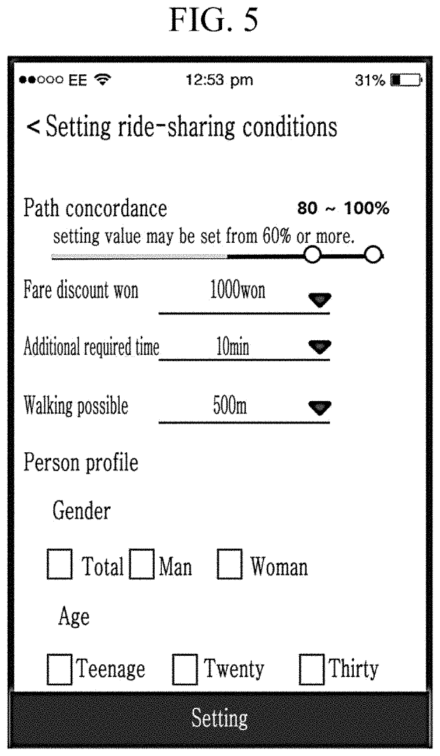

FIG. 5 is a view showing a screen provided through an application of a user terminal according to an exemplary embodiment.

Referring to FIG. 5, the ride-sharing matching server 100 may present a user interface capable of inputting the ride-sharing condition through application 210_i of the user terminal 200_i requesting the ride-sharing.

In the example of FIG. 5, the path coincidence degree condition is set to 80% or more and 100% or less. Therefore, the path coincidence degree threshold value is 80%. In addition, the ride-sharing matching server 100 may limit the path coincidence degree condition to a predetermined range or more. For example, the upper and lower limits of the path coincidence degree condition may be set as 60% or more.

In the example of FIG. 5, the additional fare discount condition is set to 1000 won, the additional travel time condition is set to 10 minutes, and the walking distance condition is set to 500 m.

In the example of FIG. 5, personal information conditions such as a gender and an age may be set.

In FIG. 2, the ride-sharing matching server 100 receives the call request and the ride-sharing request from another user terminal 200_j (S300). The call request and the ride-sharing request may be received from a plurality of user terminals, but for convenience of explanation, it is described that the call request and the ride-sharing request are received from a specific terminal, that is, another user terminal 200_j.

Hereinafter, it is described that the time at which the ride-sharing matching server 100 receives the ride-sharing request from the user terminal 200_i is earlier than the time at which the ride-sharing request is received from the other user terminal 200_j. At this time, the user of the user terminal 200_i may already be in the vehicle and moving.

The ride-sharing matching server 100 receives a ride-sharing condition from another user terminal 200_j (S400).

Another user terminal 200_j may transmit the input ride-sharing condition to the ride-sharing matching server 100 when the ride-sharing condition is input from another user.

In addition, the ride-sharing matching server 100 may store the ride-sharing request and the ride-sharing condition received from the other user terminal 200_j in the database 160.

The ride-sharing matching server 100 matches the user with another user in consideration of the ride-sharing request and the ride-sharing condition (S500).

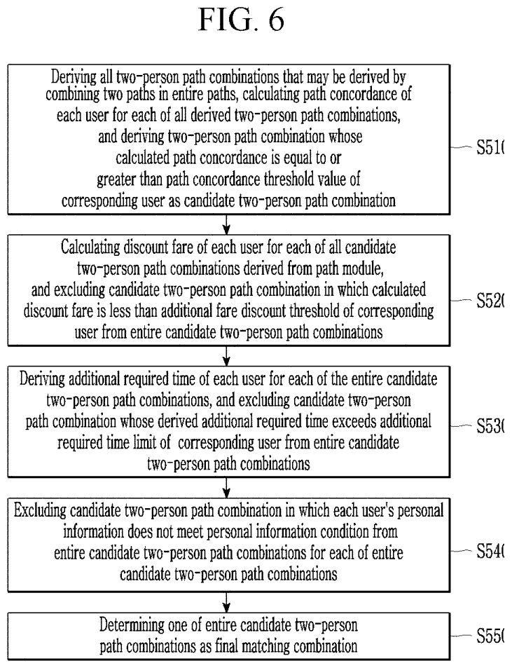

FIG. 6 is a detailed flowchart showing a matching step of FIG. 2.

In FIG. 6, the ride-sharing matching server wo may sequentially determine whether it is matched through each module 110 to 150.

The path module no may derive all combinations (hereinafter, a two-person path combination) that may be derived by combining two paths in a plurality of paths (hereinafter, an entire path) of a plurality of users who request the ride-sharing, calculate the path coincidence degree of each user for each of the all derived two-person path combinations, and derive the two-person path combination whose calculated path coincidence degree is equal to or greater than the path coincidence degree threshold value of the corresponding user as a candidate two-person path combination (S510). At this time, the path coincidence degree of each of two users constituting the candidate two-person path combination is greater than or equal to the path coincidence degree threshold value included in the ride-sharing condition of the corresponding user.

If up to 3 persons may ride together, the path module no derives all three-person combinations that may be derived by combining three paths in the entire path, calculate the path coincidence degree of each user for each of all derived three-person combinations, and derive the three-person combinations in which the calculated path coincidence degree is equal to or greater than the path coincidence degree threshold value of each corresponding user as the candidate three-person combination. At this time, the path coincidence degree of each user constituting the candidate three-person combination is greater than or equal to the path coincidence degree threshold value included in the ride-sharing condition of the corresponding user.

In the same way as above, the path module no can derive the candidate path combination according to each of the number of persons who may ride together. Hereinafter, for convenience of explanation, the candidate path combination is described as the two-person path combination.

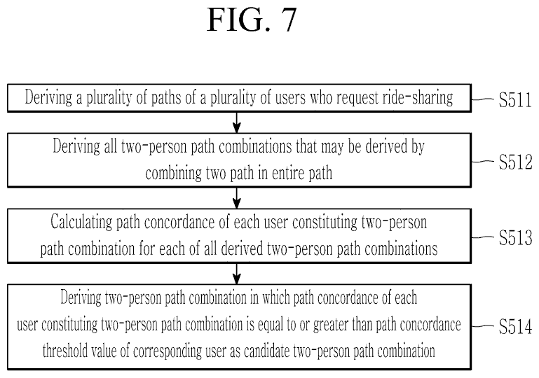

FIG. 7 is a detailed flowchart showing a step (S510) of FIG. 6.

In FIG. 7, the path module no derives a plurality of paths of a plurality of users who request the ride-sharing (S511).

The path module no may derive the path moving from the departure to the destination via the vehicle on the basis of the departure and destination of each user requesting the ride-sharing. Here, the path may include a recommended path, a general path, and an optimal path.

When the user of the user terminal 200_i is already in the vehicle and is moving, the path module no may derive the path by using the position of the user terminal 200_i as the departure point.

The position information of the user terminal 200_i may be received by the ride-sharing matching server 100 from the user terminal 200_i. Here, the position information may indicate a position recognized through a GPS device included in the user terminal 200_i or the like at the time when the user terminal 200_i transmits the position information.

The path module no derives all two-person path combinations that may be derived by combining two paths in the entire path (S512). For example, the path module no may derive nC2 two-person path combinations when the number of the users requesting the ride-sharing is n.

The path module no calculates the path coincidence degree of each user constituting the two-person path combination for each of all derived two-person path combinations (S513).

The path module no may calculate the path coincidence degree of each user by comparing each path of all users constituting the two-person path combination with each other and quantifying the degree of the concordance.

The path coincidence degree of each user constituting the single two-person path combination may be different. For example, in the two-person path combination where 50% of the user entire path is the same as another user's entire path, it may be calculated that the user's path coincidence degree is 50%, and the path coincidence degree of another user is 100%.

The path module no sequentially compares the recommended path, the general path, and the optimal path of the user with the recommended path, the general path, and the optimal path of another user.

For example, the path module no for the user's path and the other user's path may determine the combination with high path coincidence degree as the two-person path combination by comparing in the order of (recommended-recommended), (recommended-general), (recommended-optimal), (general-recommended), (general-general), (general-optimal), (optimal-recommended), (optimal-general), and (optimal-optimal).

The path coincidence degree may be expressed as a value between 0% and 100%.

The path module no derives the two-person path combination in which the path coincidence degree of each user constituting the two-person path combination is equal to or greater than the path coincidence degree threshold value of the corresponding user as the candidate two-person path combination (S514).

For example, if the user's path coincidence degree is 50%, the path coincidence degree of another user is 100%, the path coincidence degree threshold value included in the user's ride-sharing condition is 70%, and the threshold value of another user is 80%, the two-person path combination of a user and another user may not be derived as the candidate two-person path combination.

The path module no may determine the path (hereinafter, a combination movement path) that is changed for the candidate two-person path combination derived through the ride-sharing matching. The path module no may generate a plurality of paths passing through the departure and destination of two users belonging to the candidate two-person path combination, and determine one of a plurality of paths as the combination movement path in consideration of a travel distance, a travel time, a user preference, etc.

Here, a plurality of the candidate two-person path combinations may be derived.

The path module no may terminate the procedure if there is no candidate two-person path combination to derive.

When the number of people capable of ride-sharing is three or more, the path module no may sequentially derive the candidate three-person combination, the candidate four-person path combination, and the like in the same manner following the derivation of the candidate two-person path combination. In this case, the candidate path combination derived by the path module no may include the candidate two-person path combination, the candidate three-person combination, and the like.

In FIG. 6, the fare module 120 may calculate a discount fare for each user for each of all the candidate two-person path combinations derived from the path module 110, and exclude the candidate two-person path combination in which the calculated discount fare is less than the additional fare discount threshold of the corresponding user from the entire candidate two-person path combinations (S520). The entire candidate two-person path combination represents all the candidate two-person path combinations derived in the step (S514) above.

The fare module 120 may calculate the discount fare applicable to each user when each user of the candidate two-person path combination is riding in the vehicle together with another user matched with the candidate two-person path combination.

The discount fare may be derived based on a predetermined method. For example, the discount fare may be calculated based on the path coincidence degree.

Each user's discount fare in one two-person path combination may be different.

If at least one discount fare among two users constituting the candidate two-person path combination is less than the corresponding additional fare discount threshold, the fare module 120 may exclude the candidate two-person path combinations from the entire candidate two-person path combinations.

In the following description, the entire candidate two-person path combinations represent at least one of the candidate two-person path combinations excluded by the fare module 120 and remaining.

The fare module 120 may terminate the procedure if there is no remaining candidate two-person path combination.

The time module 130 may derive the additional required time of each user for each of the entire candidate two-person path combinations, and exclude the candidate two-person path combinations in which the derived additional required time exceeds the additional required time limit of the corresponding user from the entire candidate two-person path combinations (S530).

The time module 130 may derive an estimated time required for the vehicle to move along the path of an individual movement of each user constituting the candidate two-person path combinations and an additional estimated time required for the vehicle to move along the combination movement path.

The combination movement path may be a path including a point where each user gets on and off the vehicle. The point at which the user boards the vehicle may be included in an area within a predetermined distance based on the user's departure point. In addition, the point at which the user gets off the vehicle may be included in an area within a predetermined distance based on the destination of the user. Here, the predetermined distance may be set as initial information.

The additional required time may represent an additionally expected time required for the vehicle to move along the combination movement path, compared to the estimated time required for the vehicle to move along the user's path when moving alone.

The estimated additional required time for each user constituting one two-person path combination may be different.

The time module 130, when at least one additional required time of two users constituting the candidate two-person path combination exceeds the corresponding additional required time limit, may exclude the corresponding candidate two-person path combination from the entire candidate two-person path combinations.

In the following description, the entire candidate two-person path combinations represent at least one candidate two-person path combination left after being excluded by the time module 130.

The time module 130 may terminate the procedure if there is no remaining candidate two-person path combination.

The personal information module 140, for each of the entire candidate two-person path combinations, may exclude the candidate two-person path combinations in which each user's personal information does not meet the personal information condition from the entire candidate two-person path combinations (S540). Here, each user's personal information may be received from the user terminal 200_i of the corresponding user. The personal information conditions may include a gender, an age, an occupation, a safety score, etc. for another user that the user may allow for the ride-sharing.

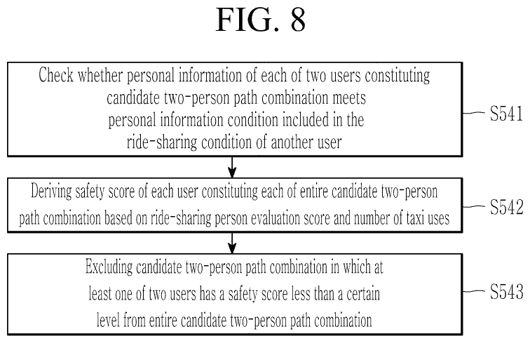

FIG. 8 is a detailed flowchart showing a step (S540) of FIG. 6.

In FIG. 8, the personal information module 140 may check whether the personal information of each of two users constituting the candidate two-person path combination meets the personal information condition included in the ride-sharing condition of another user (S541). The personal information may include the gender, age, occupation, and the like of the user.

The personal information module 140 may derive the safety score of each user constituting each of the entire candidate two-person path combinations based on the ride-sharing person evaluation score and the number of taxi uses (S542). The ride-sharing person evaluation score and the number of taxi uses may be data stored in the database 160. Here, the ride-sharing person evaluation score may be an evaluation score for the user given by another user when the user moves while ride-sharing with other users in the vehicle.

The personal information module 140 may exclude the candidate two-person path combination in which at least one of two users has a safety score of less than a certain level from the entire candidate two-person path combinations (S543). Here, a certain level may be set as initial information.

In the following description, the entire candidate two-person path combinations represent at least one candidate two-person path combination excluded by the personal information module 140 and remaining.

The personal information module 140 may terminate the procedure if there is no remaining candidate two-person path combination.

In FIG. 6, it is progressed in the order of the steps S520, S530, and S540, but the invention is not limited thereto. The sequence of the steps S520-S540 may be different from the contents shown in FIG. 6.

In FIG. 6, the matching module 150 may determine one of the entire candidate two-person path combinations as the final matching combination (S550). The matching module 150 may ride-sharing person-match the users constituting the final matching combination.

The matching module 150 may determine the candidate two-person path combination as the final matching combination when the number of the entire candidate two-person path combinations is one.

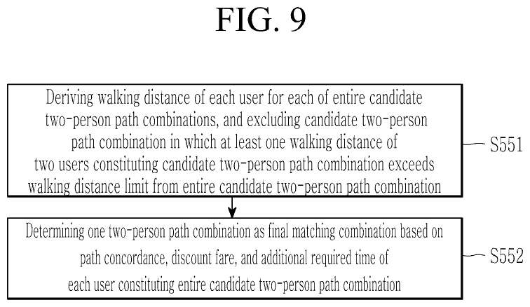

FIG. 9 is a detailed flowchart showing a step (S550) of FIG. 6 when a number of the entire candidate two-person path combinations is multiple.

The matching module 150, when the entire candidate two-person path combinations is plural, based on the walking distance, the path coincidence degree, the discount fare, and the additional required time of each user constituting each candidate two-person path combination, may determine one two-person path combination as the final matching combination.

In FIG. 9, the matching module 150 may derive the walking distance of each user for each of the entire candidate two-person path combinations, and exclude the candidate two-person path combination in which at least one walking distance of two users constituting the candidate two-person path combination exceeds the walking distance limit from the entire candidate two-person path combinations (S551). The matching module 150 may proceed with the step S551 only when the walking distance limit is included in the ride-sharing condition received from the user terminal.

The walking distance may represent a distance that the user is expected to move on foot from the point where the user gets off the vehicle to the destination. The walking distance may represent a distance expected to move on foot from the disembarkation point to the destination along the combination movement path.

The matching module 150 may determine one two-person path combination as the final matching combination based on the path coincidence degree, the discount fare, and the additional required time of each user constituting the entire candidate two-person path combinations (S552).

For example, when the entire candidate two-person path combinations include only the two-person path combination A and the two-person path combination B, and the path coincidence degrees of each user of the combination A are 70% and 75%, respectively, the path coincidence degree of each user of the combination B are 80% and 90%, respectively, and the discount fare and additional required time conditions of the combination A and the combination B are all the same, the matching module 150 may determine the combination B as the final matching combination.

The matching module 150 may derive the candidate two-person path combination in which each departure and/or each destination of a user and another user match each other as the final matching combination in preference to the candidate two-person path combination that does not match.

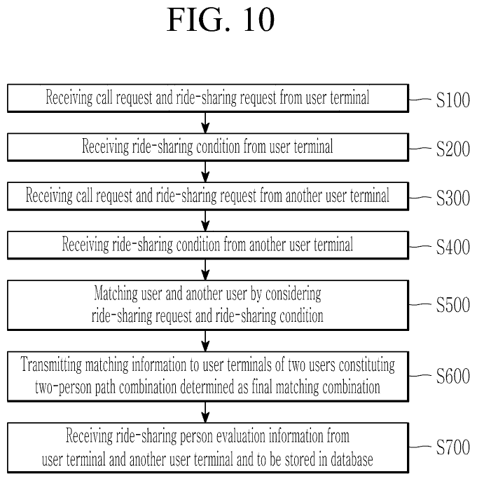

FIG. 10 is a flowchart of a ride-sharing matching method according to an exemplary embodiment.

The steps S100-S500 of FIG. 10 may be applied in the same way as the steps S100-S500 of FIG. 2.

The matching module 150 may transmit the matching information to the user terminals 200_i and 200_j of two users constituting the two-person path combination determined as the final matching combination (S600).

The matching information may include the path coincidence degree, the discount fare, the additional required time, the personal information of the ride-sharing person, and the combination movement path. The combination movement path may include the information on the departure, the destination, the boarding point, and the disembarkation point of each of two users constituting the two-person path combination.

The matching module 150 may receive the ride-sharing person evaluation information from the user terminal 200_i and another user terminal 200_j and store it in the database 160 (S700).

The matching module 150 may present a user interface capable of receiving the ride-sharing person evaluation information through each application 210_i and 210_j of the user terminal 200_i and another user terminal 200_j after the vehicle is boarded.

The ride-sharing person evaluation information may include a score evaluated by each user constituting the final matching combination with respect to another user constituting the final matching combination.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A ride-sharing matching method, the method comprising:
receiving a call request, a ride-sharing request, and a ride-sharing condition from each of a plurality of user terminals;
deriving a plurality of paths drivable by a vehicle for each of the ride-sharing requests;
deriving at least one path combination by tying at least two paths among the plurality of paths; and
determining a final matching combination comprising the path combination that satisfies each of the ride-sharing conditions based on a path coincidence degree threshold value, an additional fare discount threshold value, an additional required time limit, and a personal information condition.

2. The method of claim 1, wherein determining the final matching combination comprises:
deriving a path coincidence degree between a path of a first user traveling in the vehicle alone and a path of a second user traveling in the vehicle alone; and
deriving at least one candidate path combination based on the path combination having the path coincidence degree equal to or greater than the path coincidence degree threshold value.

3. The method of claim 2, wherein determining the final matching combination comprises excluding a corresponding path combination from the candidate path combination in response to a discount fare applied during ride-sharing being less than the additional fare discount threshold value.

4. The method of claim 2, wherein determining the final matching combination comprises excluding a corresponding path combination from the candidate path combination in response to an additional required time expected to be required for ride-sharing exceeding the additional required time limit in comparison to the first user or the second user traveling alone.

5. The method of claim 2, wherein determining the final matching combination comprises excluding a corresponding path combination from the candidate path combination in response to personal information of the first user or the second user not meeting the personal information condition.

6. The method of claim 5, wherein excluding the corresponding path combination from the candidate path combination comprises:
deriving a safety score of the second user based on an evaluation score for the second user and a number of taxi use times of the second user; and
excluding the corresponding path combination from the candidate path combination in response to the safety score of the second user being less than a certain level.

7. The method of claim 2, wherein deriving the candidate path combination comprises deriving a combination movement path modified by combining the paths of the first user and the second user constituting the path combination.

8. The method of claim 7, wherein determining the final matching combination further comprises excluding a corresponding path combination from the candidate path combination in response to a walking distance of the first user or the second user according to the combination movement path exceeding a corresponding walking distance limit.

9. The method of claim 1, further comprising transmitting matching information to the user terminals of the plurality of user terminals corresponding to the final matching combination.

10. The method of claim 9, wherein the matching information comprises a path coincidence degree, a discount fare, an additional required time, personal information of each user of the user terminals corresponding to the final matching combination, and a combination movement path.

11. The method of claim 1, further comprising receiving an evaluation score for each user of the user terminals of the plurality of user terminals corresponding to the final matching combination.

12. A ride-sharing matching system, the system comprising:
a ride-sharing matching server configured to:
derive a plurality of paths that are movable via a vehicle for each of a plurality of users using a plurality of user terminals;
tie at least two paths among the plurality of paths to derive at least one path combination; and
determining, in response to receiving a call request, a ride-sharing request, and a ride-sharing condition from each of the plurality of user terminals, a final matching combination comprising the path combination that satisfies ride-sharing conditions.

13. The system of claim 12, wherein the ride-sharing matching server comprises a path module configured to derive the path combination as a candidate path combination based on a path coincidence degree of a path of a first user in the path combination with a path of a second user in the path combination being greater than or equal to a path coincidence degree threshold value of the first user.

14. The system of claim 13, wherein the ride-sharing matching server further comprises a fare module configured to exclude a corresponding path combination as the candidate path combination based on a discount fare applied to the first user being less than an additional fare discount threshold value of the first user during the vehicle ride-sharing of the first user and the second user.

15. The system of claim 13, wherein the ride-sharing matching server further comprises a time module configured to exclude the path combination as the candidate path combination based on an expected additional required time for the first user exceeding an additional required time limit of the first user upon the vehicle ride-sharing of the first user and the second user.

16. The system of claim 13, wherein the ride-sharing matching server further comprises a personal information module configured to exclude a corresponding path combination as the candidate path combination based on personal information of the second user not meeting a personal information condition of the first user.

17. The system of claim 16, wherein the personal information module is configured to derive a safety score of the second user based on an evaluation score for the second user and a number of taxi uses of the second user.

18. The system of claim 17, wherein the personal information module is configured to exclude a corresponding path combination as the candidate path combination based on the derived safety score being less than a certain predetermined level.

19. The system of claim 13, wherein the ride-sharing matching server further comprises a matching module configured to receive an evaluation score for the second user in the final matching combination from the user terminal for each user in the final matching combination.
